(19) United States
(12) Patent Application Publication
(10) Pub. No.: US 2019/0134584 A1
(43) Pub. Date: May 9, 2019

(54) FLUIDIZED BED INSTALLATION

(71) Applicant: Robert Bosch GmbH, Stuttgart (DE)

(72) Inventors: Matthias Boerner, Schopfheim (DE); Uwe Schmidt, Schopfheim (DE)

(21) Appl. No.: 16/306,962

(22) PCT Filed: Apr. 27, 2017
(86) PCT No.: PCT/EP2017/060008

§ 371 Date: Dec. 4, 2018

(30) Foreign Application Priority Data
Jun. 8, 2016 (DE) 10 2016 210 062.9

(51) Int. Cl. B01J 2/16; B01D 39/08; B01D 39/12; B01D 45/12; B01J 2/00; F26B 3/08

(52) U.S. Cl. CPC B01J 2/16; B01D 39/08; F26B 3/08; B01D 45/12; B01J 2/003; B01D 39/12

(57) ABSTRACT

The invention relates to a fluidized bed installation (1), comprising at least two chambers (2, 3, 4), wherein each chamber (2, 3, 4) has a main body (5) and a gas inlet (6) and a gas outlet (7), wherein each main body (5) has an inlet (8) and an outlet (9) for a solid (19), wherein the inlet (8) of a first chamber (2) is connected to a feed (10) of the fluidized bed installation (1), the outlet (9) of the first chamber (2) is connected to the inlet (8) of a second chamber (4), and the outlet (9) of the second chamber (4) is connected to a discharge (11) of the fluidized bed installation (1), and wherein a valve (12) is arranged between two connected chambers (2, 3, 4) and/or at the feed (10) and/or at the discharge (11) such that either continuous operation or semi-continuous operation of the fluidized bed installation (1) is enabled.

### BACKGROUND OF THE INVENTION

The present invention relates to a fluidized bed installation. Such fluidized bed installations are known for example from DE 10 2012 009 280 A1 or EP 1 407 814 A1.

### SUMMARY OF THE INVENTION

The fluidized bed installation according to the invention allows a plurality of different working steps to be performed. For instance, the fluidized bed installation according to the invention in particular allows drying of granules or powders, granulation of powders, coating of granules, powders or pellets, as well as fully automated operation without manual intermediate steps. To this end, the fluidized bed installation comprises at least two chambers, wherein each chamber comprises a main body and a gas inlet and a gas outlet. A gas, preferably air, may be fed to each chamber via the gas inlet, wherein the gas may be removed via the gas outlet. The gas is fed to the gas inlet in particular through an air treatment unit with filter and heat exchanger. Furthermore, each main body comprises an inlet and an outlet for a solid. The inlet of a first chamber is in this case connected to a feed line of the fluidized bed installation. The outlet of the first chamber is connected to the inlet of a second chamber. The outlet of the second chamber is in turn connected to a discharge line of the fluidized bed installation. A solid may in particular be introduced into the fluidized bed installation via the feed line, while a solid and/or finished product may be removed from the fluidized bed installation via the discharge line. In this way, the individual chambers form a series connection. The main bodies of the chambers are in particular cylindrical in shape. The gas then flows through the main body from the gas inlet to the gas outlet in particular along a longitudinal axis of the cylinder. To establish an air velocity gradient over the height of the cylindrical main body, the main body is advantageously configured such that the cylinder diameter widens or tapers conically. To this end, the cross-sectional area of the cylinder ideally adopts a circular shape. Other cross-sectional areas are advantageously also possible. In the main body the solid, present in particular in powder form, and the supplied gas come into contact with one another. With the gas flow through the main body, the solid contained therein is set in motion and thus converted into a fluid-like state. An intensive mass exchange and heat exchange takes place in the process between the supplied gas and the solid. The solid or the product arising from the mixing of gas and solid may be transported from the first chamber into the second chamber. This in particular allows continuously operating solid treatment within the fluidized bed installation, into which solid may be added continuously via the feed line and removed via the discharge line. To transport the solid between the chambers, the inlets and/or outlets are advantageously configured so as to have a circular or oval cross-sectional area, wherein concave or convex outer contours are possible.

Furthermore, a valve is arranged between two connected chambers and/or on the feed line and/or on the discharge line. This optionally allows a semi-continuous or continuous mode of operation for the fluidized bed installation. The valves are arranged in particular in a lower third, in particular a lower quarter, of each main chamber. In this case, the lower third, in particular the lower quarter, corresponds to that region of the main body which is arranged closest to the gas inlet. Opening of the valves enables continuous operation of the fluidized bed installation, since a solid and/or a product arising inside the chambers may flow directly through all the chambers of the fluidized bed installation. If, on the other hand, the valves are closed, a solid situated inside the individual chambers cannot be exchanged between the chambers, so resulting in a semicontinuous mode of operation. This allows process steps to be carried out within the individual chambers until a predetermined product quality is achieved. The valves may then be opened, whereby the solid or the resultant product may be transferred into the subsequent chamber. Product transfer may here proceed in parallel between the individual chambers, whereby in particular half of the chambers are used simultaneously. Alternatively, sequential transfer is allowed, in which in particular all the chambers are used simultaneously.

The dependent claims contain preferred further developments of the invention.

At least one third chamber is preferably arranged between the outlet of the first chamber and the inlet of the second chamber. A plurality of third chambers is particularly advantageously arranged between the outlet of the first chamber and the inlet of the second chamber. In this way, the inlet of the third chamber is connected to the outlet of the first chamber and the outlet of the third chamber is connected to the inlet of the second chamber. If a plurality of third chambers is present, this plurality is arranged in particular by means of a series connection between the first chamber and the second chamber. Once it has left the first chamber, a solid thus has to pass through all the third chambers before reaching the second chamber. The number of desired working steps to be performed within the fluidized bed installation may be adjusted by selecting the number of third chambers. The individual chambers advantageously make it possible for individual working steps to be performed mutually independently.

In a particularly preferred embodiment of the invention, the valve functions as a weir. In this case, valve position can be used to control degree of opening for transfer between the individual chambers. In this way, a mass flow rate between the chambers may be adjusted. Particularly advantageously, in addition to the valves, additional valves in the form of weirs are used which are configured either according to the overflow principle or according to the underflow principle. Solid transfer or transfer of products arising within the chambers is thus possible.

The main body preferably has a base and/or a lid. The base comprises the gas inlet, while the lid comprises the gas outlet. Base and lid in particular provide filtering, so preventing the solid from leaving the chamber. Passage for a gas is nevertheless enabled. In this way, the fluidized bed may be produced within each chamber.

The base particularly advantageously comprises a gas distributor. The gas distributor comprises a plurality of outlet orifices, via which a gas introduced through the gas inlet may be introduced into the main body. Since each chamber comprises such a gas distributor, the inflow of gas is individually controllable for each chamber. Through inflow of the gas into each of the chambers, the solid present in the respective chamber may be converted into a fluid-like state. Gas is moreover advantageously supplied via an inflow chamber. The inflow chamber is situated in particular below the gas distributor and is supplied with predefined gas from a central gas supply. By controlling the inflow lines into the inflow chamber, separate gas mass flow rates and pressure conditions may be established for each chamber. Furthermore, different gas temperatures can be achieved in each individual chamber by way of variable admixture proportions between a preheated gas and a cold gas, in particular between hot air and cold air.

The outlet orifices of the gas distributor are in particular arranged toroidally. Thus, the solid may be set in rotation, which leads in particular to the solid performing a spiral movement around a virtual circular ring within the in particular cylindrically configured main body. Alternatively or in addition, the gas distributor comprises at least one outlet orifice in longitudinal arrangement, which allows translational transfer between the chambers of the solid or of the product arising inside each chamber. In particular, a combination of the two outlet orifice embodiments is present, so as to achieve a combination of the above-stated movements.

The base advantageously comprises additional spray nozzles. Via the spray nozzles liquid may be introduced into the main body. The liquid may in particular be used for granulation or for coating within the main body. Alternatively or in addition, spray nozzles may also be integrated into the lid, so enabling additional introduction of liquid into the main body.

The lid preferably comprises a filter element. In this case, the filter element prevents the solid from leaving the main body. In particular, each individual chamber thus has a separate filter element. The filter element is advantageously connected with a compressed air supply, in order to expose the filter element to compressed air in particular at regular intervals. In this way, the filter element may be cleaned.

The filter element particularly advantageously comprises a woven textile filter and/or a metal mesh filter and/or a gas/solid cyclone. The cyclone separates a discharged gas/solid mixture. The separated solid may thus be fed back into the main body.

Each individual chamber preferably has its own temperature measurement and/or differential pressure measurement. Provision is moreover preferably made for each chamber to be provided with a measurement point which allows inline measurements, such as in particular for product moisture level, particle size, composition or the like. During a drying process and granulation process within the fluidized bed installation, the process conditions in each individual chamber may be controlled, via inline measurement of the product moisture level, in such a way as to achieve constant product quality, i.e. a constant product moisture level. In a granulation process, it is necessary, in particular, to measure the particle size distribution during the process. These inline measurements may be of a spectroscopic kind, such as advantageously near infrared spectroscopy, absorption measurements, such as in particular using microwaves, or of an optical kind, such as advantageously image evaluations.

Subsequent to a drying process and/or granulation process using the fluidized bed installation, it is often necessary to undertake particle size calibration. To this end, the fluidized bed installation preferably has an integrated mill on the discharge line. When removing the product from the second chamber, the product must thus pass through the integrated mill. This leads to particle size calibration.

The plurality of chambers is advantageously set up in an annular arrangement or in a longitudinal arrangement. In the annular arrangement, the fluidized bed installation only has a small space requirement. Provision is moreover advantageously made for the chambers to be integrated into a pressure surge-resistant housing. If the annular arrangement is additionally selected here, the pressure surge-resistant housing may be cylindrical. The pressure surge-resistant housing has thus merely to comprise one orifice for the feed line and one orifice for the discharge line and corresponding orifices for the supply and removal of gas.

### BRIEF DESCRIPTION OF THE DRAWINGS

Exemplary embodiments of the invention are described in detail below with reference to the accompanying drawings, in which:

FIG. 1 is a schematic view of a fluidized bed installation according to a first exemplary embodiment of the invention,

FIG. 2 is a sectional view of part of the fluidized bed installation according to the first exemplary embodiment of the invention,

FIG. 3 is a schematic view of a fluidized bed installation according to a second exemplary embodiment of the invention,

FIG. 4 is a schematic view of a fluidized bed installation according to a third exemplary embodiment of the invention,

FIG. 5 is a schematic view of a valve between two chambers of the fluidized bed installation according to the first exemplary embodiment of the invention,

FIG. 6 is a schematic view of various positions of the valve of FIG. 5,

FIG. 7 is a schematic view of a first alternative of a base of a chamber of the fluidized bed installation according to the first exemplary embodiment of the invention,

FIG. 8 is a schematic view of a second alternative of a base of a chamber of the fluidized bed installation according to the first exemplary embodiment of the invention,

FIG. 9 is a schematic view of a third alternative of a base of a chamber of the fluidized bed installation according to the first exemplary embodiment of the invention, and

FIG. 10 is a schematic view of a fourth alternative of a base of a chamber of the fluidized bed installation according to the first exemplary embodiment of the invention.

### DETAILED DESCRIPTION

FIG. 1 is a schematic diagram of a fluidized bed installation 1 according to a first exemplary embodiment of the invention. The fluidized bed installation 1 comprises a plurality of chambers 2, 3, 4, wherein a first chamber 2 is arranged in series connection with three third chambers 3 and one second chamber 4. Each of the chambers 2, 3, 4 in each case comprises an inlet 8 and an outlet 9. The inlet 8 in the first chamber 2 is connected to a feed line 10 of the fluidized bed installation 1. The outlet 9 of the first chamber 2 is connected to the inlet 8 of one of the third chambers 3. The three third chambers 3 are arranged in series connection, such that in each case one inlet 8 is connected to one outlet 9. The outlet 9 of the final third chamber 3 of the series connection is connected to the inlet 8 of the second chamber 4. The outlet 9 of the second chamber 4 is connected to a discharge line of the fluidized bed installation.

A solid, in particular in powder form, may be fed to the individual chambers 2, 3, 4 via the feed line 10. As a result of the series connection, the solid firstly enters the first chamber 2, then the third chambers 3, and finally the second chamber 4.

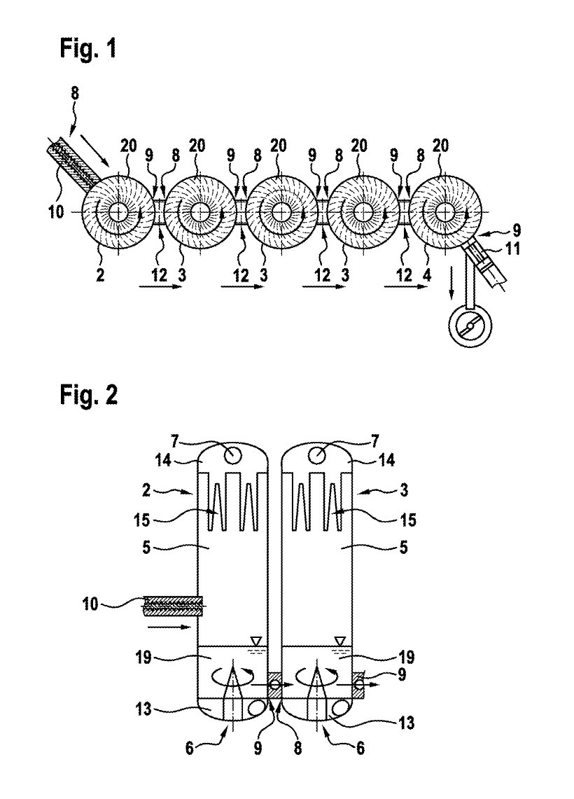

Inside the individual chambers 2, 3, 4 the solid comes into contact with a gas, in particular with air. This is shown in FIG. 2. FIG. 2 shows a sectional view through the first chamber 2 and the first third chamber 3 of the series connection of third chambers 3. It is obvious that both the first chamber 2 and the third chamber 3 are of identical construction. The second chamber 4 is preferably also of identical construction.

Each chamber 2, 3, 4 comprises a main body 5 and a base 13 and a lid 14. The base 13 is provided with a gas inlet 6, while the lid 14 comprises a gas outlet 7. Gas, in particular air, may be introduced into the main body via the gas inlet 6. A solid may moreover be introduced into the main body 5 via the respective inlets 8 of the chambers 2, 3, 4. Through contact with the flowing gas, the preferably pulverulent solid is set in motion and assumes a fluid-like state within the main body 5. The gas flows from the gas inlet 6 to the gas outlet 7 and leaves the respective chamber 2, 3, 4 via the gas outlet 7. To prevent solid from likewise leaving the chamber 2, 3, 4, the lid 14 comprises a filter element 15. The filter element 15 is advantageously a metal mesh filter. The metal mesh filter is in particular supplied with compressed air at regular intervals, in order to clean the metal mesh filter 15.

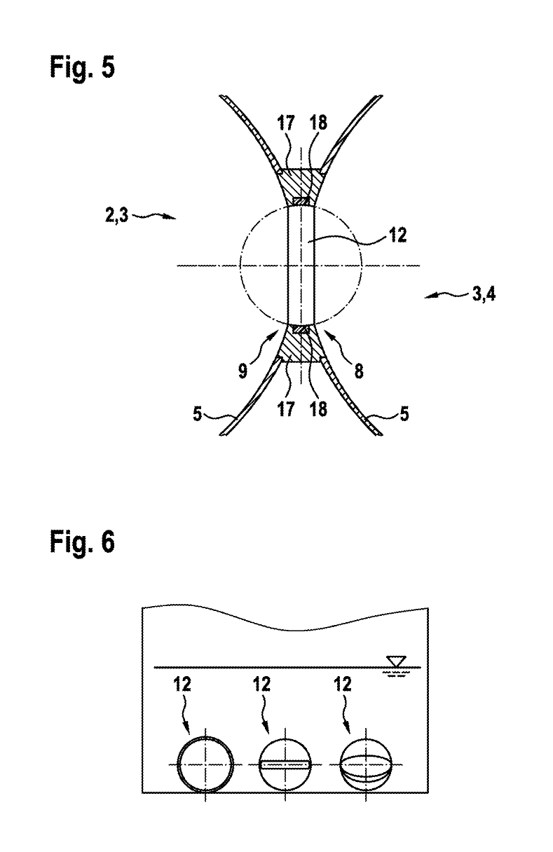

The base 13 has a gas distributor with a plurality of outlet orifices 20 (cf. FIG. 1), wherein the gas received via the gas inlet 9 enters the main body 5 via the outlet orifices 20. The gas outlet orifices 20 are in particular arranged toroidally, whereby toroidal movement of the solid 19 is present within the main body 5. Alternatively or in addition, the outlet orifices 20 may preferably be arranged at least in part so as to enable translational transfer of the solid 19 between two chambers 2, 3, 4. To control such translational transfer, a valve 12 is in particular present, which is described below with reference to FIGS. 5 and 6.

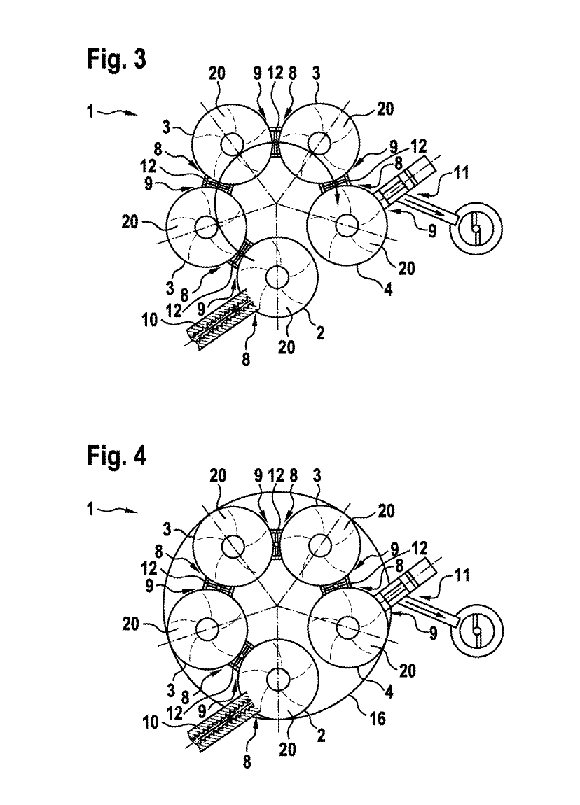

FIG. 3 shows a schematic figure of a fluidized bed installation 1 according to a second exemplary embodiment of the invention. Unlike in FIG. 1, the chambers 2, 3, 4 are arranged in a ring, so achieving a space-saving construction. Finally, FIG. 4 shows a schematic illustration of a third exemplary embodiment of the fluidized bed installation 1. This corresponds to the second exemplary embodiment, wherein a pressure surge-resistant housing 16 is additionally present. The pressure surge-resistant housing 16 thus protects the individual chambers 2, 3, 4 from external influences.

FIG. 5 is a schematic diagram of a section through two chambers 2, 3, 4, wherein the valve 12 is visible. Flanges 17 are in particular introduced between the main bodies 5 of the chambers 2, 3, 4 as valve seats for the valve 12. The flanges 17 are preferably welded to the main body 5. The main bodies 5 have an orifice which is closable by the valve 12. By intermediate positions of the valve 12, a mass flow rate between the individual chambers 2, 3, 4 may be adjusted as desired. Various positions of the valve 12, in particular a completely closed, a completely open and a partly open position, are shown in FIG. 6.

For reliable closure of the valve 12, moreover, a seal 18 is provided. The individual chambers 2, 3, 4 may thus be completely separated from one another. Once the chambers 2, 3, 4 have been separated, a semicontinuous mode of operation is possible for the fluidized bed installation 1. To this end, the first chamber 2 is filled with a solid 19, wherein the solid 19 remains in the first chamber 2 until a predefined product quality is achieved. Only then is the valve 12 between the first chamber 2 and the second chamber 3 preferably opened, in order to allow transfer of the solid between the first chamber 2 and the third chamber 3. The same applies to all the third chambers 3 and the fourth chamber 4. If, on the other hand, the valves 12 are open, a continuous operating mode is possible for the fluidized bed installation. The continuous operating mode is achieved in particular in that a solid 19 is constantly added via the feed line 10, while a solid and/or the finished product is continuously removed via the discharge line 11. Transfer between the individual chambers 2, 3, 4 takes place, in particular, due to a differential pressure between the chambers 2, 3, 4 and/or due to differences in height.

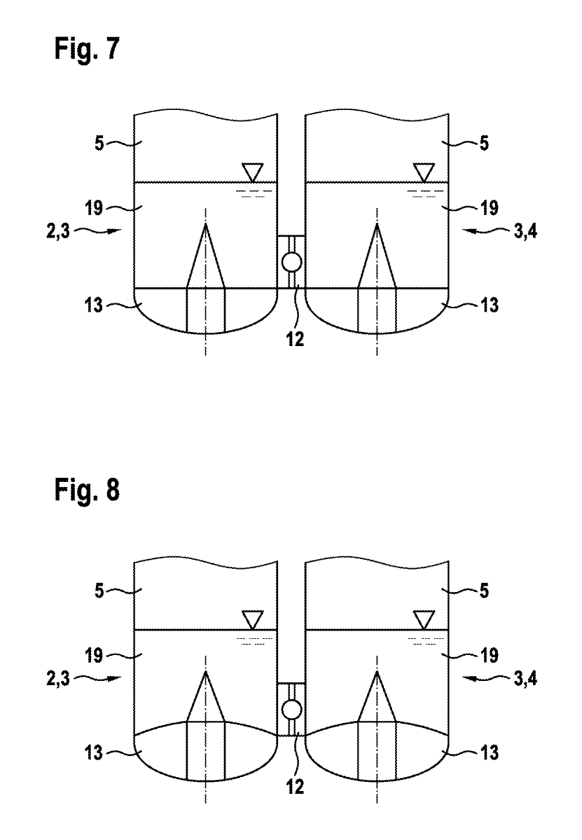

FIGS. 7 to 10 show different alternatives for the arrangement of the chambers 2, 3, 4 and the configuration of the bases 13. Thus, FIG. 7 shows a first alternative, in which the bases 13 have a straight surface. The chambers 2, 3, 4 are here at the same level.

In FIG. 8 the bases 13 have a conical or arched surface. Provision is again preferably made for the chambers 2, 3, 4 to be arranged at the same level.

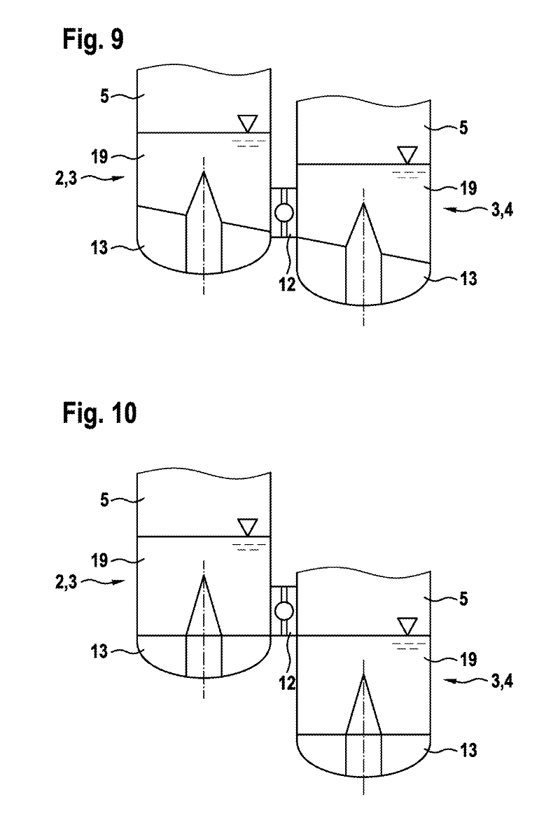

FIG. 9 shows an alternative in which the bases 13 have beveled surfaces. This is advantageously combined with the chambers 2, 3, 4 being arranged at different levels, such that the beveled surfaces of the bases 13 form a continuous inclined plane. Thus, transfer of the solid 19 between the individual chambers 2, 3, 4 is also enabled by gravity.

Finally, FIG. 10 shows an alternative in which the bases 13, as in FIG. 7, have planar surfaces. However, the chambers 2, 3, 4 are arranged at different levels. This in particular allows different filling quantities in the main bodies of the individual chambers 2, 3, 4.

In one further preferred embodiment, the fluidized bed installation additionally comprises a distribution system, wherein the distribution system is separately configured to introduce solid into and remove it from each individual chamber 2, 3, 4. This in particular enables batch operation of the fluidized bed installation 1, in that a solid 19 may be introduced into each chamber 2, 3, 4 individually and also removed again individually therefrom.

The fluidized bed installation 1 according to the present invention has the following advantages:
choice between continuous and semi-continuous process control
individually controllable chambers 2, 3, 4 for different process conditions in the individual main bodies 5, in particular with regard to temperature, air, gas velocities and spraying rates
variable process length and thus flexibility of product residence time and throughput
possibility of drying and granulation inside a fluidized bed installation 1 due to the separate chambers 2, 3, 4
step by step granulation or drying in mini batches, in order to ensure conservative process control
continuous coating, since a different coating substance can be atomized in each chamber 2, 3, 4 in order in particular to multiply functionalize drugs
bottom spray method with rotating particle bed with uniform distribution of spray liquid and permanent product wall movement to minimize incrustation of the main body 5; the bottom spray method is achieved in particular by mounting spray nozzles in the bases 13 of the chambers 2, 3, 4.

1. A fluidized bed installation (1) comprising at least two chambers (2, 3, 4), the at least two chambers including a first chamber (2) and a second chamber (4),
wherein each of the at least two chambers (2, 3, 4) has a main body (5), a gas inlet (6) and a gas outlet (7),
wherein each main body (5) has an inlet (8) and an outlet (9) for a solid (19),
wherein the inlet for a solid (8) of the first chamber (2) is connected to a feed line (10) of the fluidized bed installation (1), the outlet for a solid (9) of the first chamber (2) is connected to the inlet for a solid (8) of the second chamber (4) and the outlet for a solid (9) of the second chamber (4) is connected to a discharge line (11) of the fluidized bed installation (1), and
wherein a valve (12) is arranged between two the first and second chambers (2, 3, 4) and/or on the feed line (10) and/or on the discharge line (11), so as optionally to allow continuous or semicontinuous operation of the fluidized bed installation (1), for a solid

2. The fluidized bed installation (1) as claimed in claim 1, characterized in that the at least two chambers include at least one third chamber (3) arranged between the outlet for a solid (9) of the first chamber (2) and the inlet for a solid (8) of the second chamber (4), such that the inlet for a solid of the third chamber (3) is connected to the outlet for a solid (9) of the first chamber (2) and the outlet for a solid (9) of the third chamber (3) is connected to the inlet (8) of the second chamber (4).

3. The fluidized bed installation (1) as claimed in claim 1, characterized in that the valve (12) includes a weir.

4. The fluidized bed installation (1) as claimed in claim 1, characterized in that the main body (5) has a base (13) and a lid (14), wherein the base (13) comprises the gas inlet (6) and the lid (14) comprises the gas outlet (7).

5. The fluidized bed installation (1) as claimed in claim 4, characterized in that the base (13) comprises a gas distributor, wherein the gas distributor has a plurality of outlet orifices (20) via which a gas introduced through the gas inlet (6) may be introduced into the main body (5).

6. The fluidized bed installation (1) as claimed in claim 5, characterized in that the outlet orifices (20) are arranged toroidally.

7. The fluidized bed installation (1) as claimed in claim 4, characterized in that the base (13) has spray nozzles via which a liquid may be introduced into the main body (5).

8. The fluidized bed installation (1) as claimed in claim 4, characterized in that the lid (14) has a filter element (15), wherein the filter element (15) prevents the solid (19) from leaving the main body (5) through the gas outlet (7).

9. The fluidized bed installation (1) as claimed in claim 8, characterized in that the filter element (15) comprises a woven textile filter and/or a metal mesh filter and/or a gas/solid cyclone.

10. The fluidized bed installation (1) as claimed in claim 1, further comprising a mill, which is integrated into the discharge line (11).
